(19) United States
(12) Patent Application Publication
(10) Pub. No.: US 2004/0045153 A1
(43) Pub. Date: Mar. 11, 2004

(54) Method and tool for producing a press joint connection

(76) Inventor: Eugen Rapp, Berg (DE)

Correspondence Address: Orum & Roth, 53 West Jackson Boulevard, Chicago, IL, 60604, US

(21) Appl. No.: 10/257,041

(22) PCT Filed: Apr. 4, 2001
(86) PCT No.: PCT/DE01/01289

(30) Foreign Application Priority Data
Apr. 5, 2000 (DE) 100 16 780.2

(51) Int. Cl. B23P 11/00

(52) U.S. Cl. 29/521

(57) ABSTRACT

The invention relates to a method and tool for producing a press joint connection. According to the invention, portions of the radial lateral walls of the matrix opening (3) are configured as flexible displaceable segments, whereas other sections (5), when viewed from the periphery of the matrix opening (3), remain rigidly connected to the die.

### Technical Status

The invention consists of a method of connecting construction parts such as plates, bolts, nut, etc. with a plate by using a press joint connection of a type based on the primary claim or a tool based on the title of secondary claim 4.

In one recognized method based on the same type (DE-OS 35 32 900), the material that is displaced from the plate into the lower die opening flows outward in a radial motion to the walls of lower die opening because of the base of the lower die, whereby the displaced material grips the rim of the opening produced by the die and therefore creates a solid connection between the construction element and the plate. This method of connection is normally called a press joint connection. It can be used for connecting two or more stacked plates or for connecting bolts etc. to one or more plates whereby the so-called lost die that is used is either made of soft formable material which is hard enough to perform one press through the plate or to make the corresponding radial cavity within which the displaced plate material can be formed.

The disadvantage of this extremely quick and precise press joint connection with a lower die having inflexible restricting walls is that it leads to connection points having a limited elasticity.

### THE INVENTION AND ITS ADVANTAGES

The method based on the invention with the characterizing features of the primary claim and the tool based on the invention with its characterizing features from claim 4 have the advantage that at a high degree of functionality security, a higher elasticity connection is made in manufacturing the connection point between equal segments so that the final technical shear and head traction values are higher than for the connection points mentioned above. The elasticity that is achieved is advantageous in that the ability to work using the method and the tool are retained.

Along with the tool, there is also the advantage that the flexible radial segments that flow outward always land back in their original positions after the operating cycle. There are tools that are recognized which have the radial restricting walls of the lower die made of flexible sections (DE-OS 44 35 460 and DE-GM 297 00 868) but these have the disadvantage that all sections are positioned flexibly so that remnants of the processed material can get caught in between the individual sections in such a way that the sections can no longer return to their original positions, thus decreasing the ability to produce the required connection quality.

Based on an advantageous version of the method based on the invention, the distribution of the radial resistance in reference to the circumference of the lower die opening is centrally symmetrical. This achieves even strength on the connection points.

Another advantageous version of the invention supplements the press joint connection with adhesive elements.

Another advantageous version of the invention as a tool according to secondary claim 4, the segment height matches the depth of the sack opening which ensures that the base of the sack opening remains at its own level even with the enlarged sack opening caused by the flexed segmentation.

In another version of the invention the volume of the material to be displaced in the initial position (before the assembly procedure) is a bit more than the volume of the sack opening minus the intrusion volume of the form die. The extra volume causes radial movement of the segments.

In another version of the invention, the segments can move against a tension force. The tension can be created in different ways but the main thing is that the segments return to their original positions after the work procedure and the return of the die or the removal of the connection point from the lower die opening.

In another version of the invention, the segments are fed into cavities which run into the same level as the base of the sack opening and have guide bands on the sides which run in the radial movement direction of the segments. Any remaining material is pushed back and discarded with this method without any danger of it being pushed into a gap or reducing the functionality.

Based on another version of the invention, the opposing guide walls of the segments run parallel to inflexible wall segments.

Another version of the invention has leaf or bar springs for tension on the die. Besides this type of spring being easy to implement and secure in their functionality, they take up a minimum amount of space.

In another version of the invention the segments are run in grooves of the die which results in the ability to decrease the radial dimensions.

In a further version of the invention the springs on the far end of the segments are connected together as one piece over a connecting section whereby there is an offset of the same in the junction section between the connecting section and the springs, in the direction of the casing parts. This allows the segments to connect together better and the spring system is extremely economical to manufacture. There is also a very significant reduction in the danger of breakage's occurring or other kinds of breakdown.

In a further relevant advantageous version of the invention the connecting section is located in a jointing section of the lower die which runs transverse to the direction of the drive and which allows the connecting section to be permanently integrated into the lower die.

In a further version of the invention this connecting section is made in a cross or star form depending on how many springs must be connected together.

In a further version of the invention there are grooves made in a longitudinal direction and/or on the face side in the mould parting section to receive the springs and /or the connecting section. This allows one to obtain an assembly as a lower die which is self-contained and therefore more easily installed and removed. Another advantage not even mentioned yet is reduction of damage due to external interventions.

Further advantages and advantageous versions of the invention can be taken from the following description, drawing and claims.

### DRAWING

One embodiment of the invention in a variety of versions is shown in the drawing and will be described in more detail below. This shows:

FIG. 1 the tool in an exploded diagram and in a part-section drawing according to I in FIG. 2,

FIG. 2 a part-section drawing according to II- II in FIG. 1,

FIGS. 3-5 versions of the example embodiment of the invention

### A DESCRIPTION OF THE EXAMPLE EMBODIMENT OF THE INVENTION

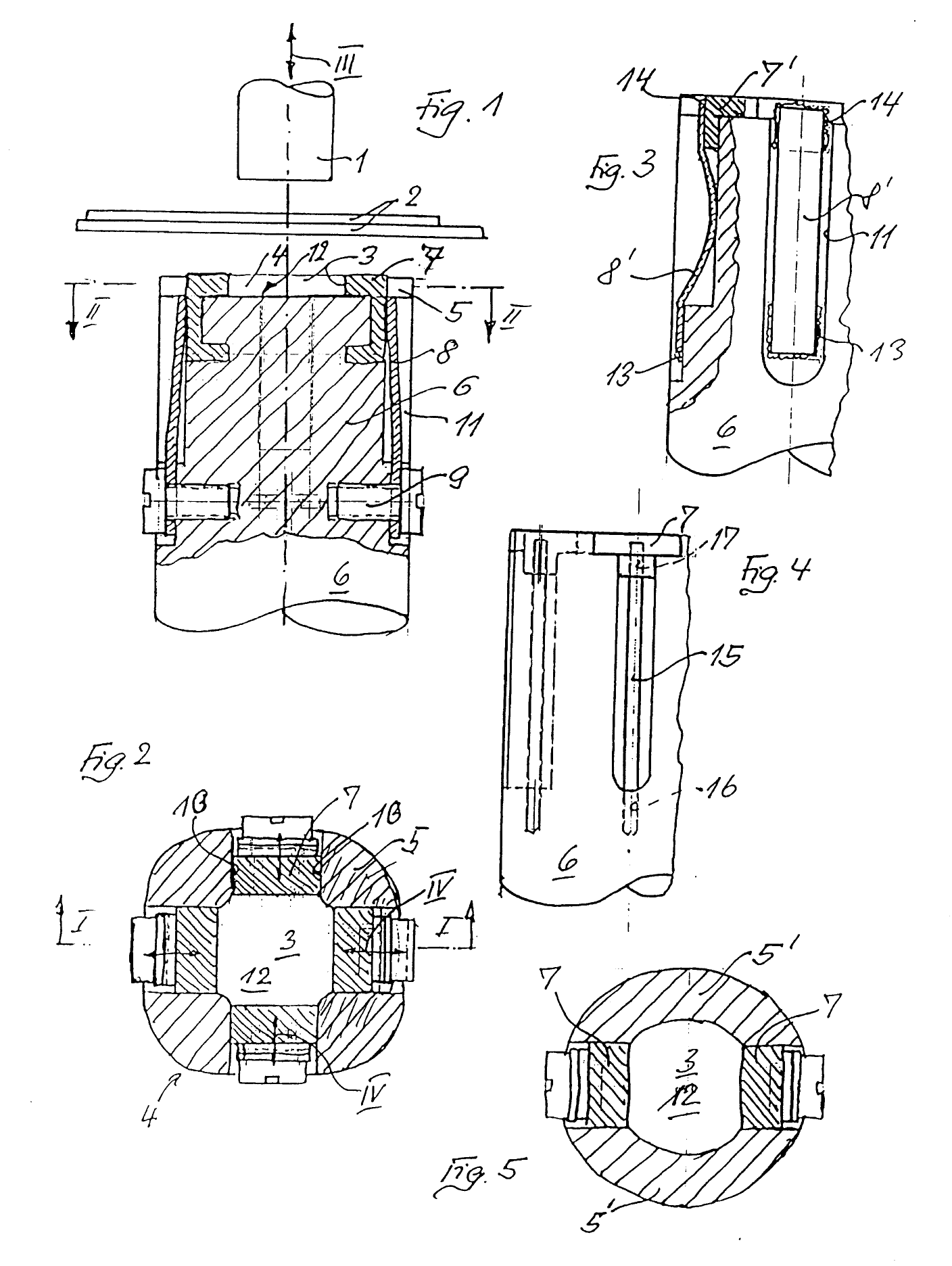

FIG. 1 shows an exploded diagram of a novel tool that is a punch 1 which can be actuated according to Arrow III over the range of its working stroke and is capable of pressing the two opposing plates 2 into the opening 3 of a die 4. The die consists of the fixed sections 5 of a forging die 6 as well as the segments 7 which can be moved axially outwards and which are actuated by leaf springs 8 in the starting position as shown. The leaf springs 8 are fixed to the forging die 6 over screws 9 and are located in a longitudinal groove of the forging die 6. The opening 3 is limited at its bottom by a base 12 which is created by the forging die 6.

As shown in FIG. 2, the segments 7 between the fixed sections 5 of the forging die 6 can be moved radially, guided by the guide walls 13 on the fixed sections 5 of the forging die. Movement causes segments 7 to slide over the base 12 of the blind opening 3.

This movement causes segments 7 to be moved according to the displacement stroke IV. The press joint connection is achieved in that the plates 2 are laid on the die 6, the corresponding parts of the surface pressed deeply into the blind opening 3 down to the bottom of the opening 12 by the punch 1 and then squashed together, so that the material is pushed radially outwards to the fixed sections 5 as well as segments 7 which form the radial wall of the blind opening 3. While the displaced material is held back by the fixed sections 5 of the die 4, the material in-between is displaced against the movable segments which give so that the material can flow after them. This, as described at the beginning, is how a differing structure of the connecting point is created.

FIG. 3 shows a version of the example embodiment of the invention in which the leaf spring 8 is welded to the die at 13 and the segment. This creates a fixed connection, most importantly that of the segment 7 to the tool.

FIG. 4 shows a second version of this example, embodiment of the invention where a spring-pin 15 is used instead of a leaf spring 8 and is placed inside corresponding bore holes 16 of the die 6 or 17 of the segment 7.

While the object shown in FIG. 2 has 4 segments 7 the version shown in FIG. 5 only has two such movable segments 7. The fixed sections 5 of this lower die are made wider accordingly and the structure of the connecting node is also correspondingly different.

All of the embodiments described in the following claims and drawing can be used on their own or in any desired combination with each other in a novel fashion.

List Of Reference Numbers

1 Punch

2 Plates

3 Opening

4 Lower die

5 Sections

6 Die

7 Segment

8 Leaf spring

9 Screws

10 Wall openings

11 Longitudinal groove

12 Bottom

13 Weld

14 Weld

15 Spring-pin

16 Bore hole

17 Bore hole

I Cut-out in FIG. 2

II Cut-out in FIG. 1

III Working stroke

IV Displacement stroke

Process of Connecting Components Together

1. A process for connecting components (such as plates, bolts, nuts and such items) to a plate (2) by creating a press joint connection by which a punch 1 or similar item punches parts of the surface of the plate (2) into a lower die opening (3) situated on the opposite side, draws or presses the material into the opening and also squashes the plate material at the bottom of the lower die opening (3), transverse to the direction of the axis, which afterwards catches hold of the stationary part of the part (2) to produce a form and/or press-fit friction-locked connection, characterized by the fact that the material which is displaced in a transverse direction differs in amount according to the differing radial resistances existing over the circumference of the lower die which leads to differing amounts of material being used and therefore differing elasticity.

2. A process according to claim 1 characterized by the fact that distribution of the radial resistance relative to the circumference of the lower die opening (3) is centrally symmetrical.

3. A process according to claim 1 or claim 2 characterized by the fact that the press joint connection is supplemented by the introduction of an adhesive.

4. A tool which is particularly suitable for implementing the process described in prior claims 1 to 3,
with a molded punch (1) or similar tool and a blind opening (3) with radially oriented movement restricting walls located in the direction of travel of the molded punch (1) and a lower die (4, 6) with a bottom (12) and
with dimensions of the punch (1) or similar tool and the blind opening (3) which match the amount of material to be displaced, characterized by the fact
that more sections of the restricting walls than there are wall openings are created as guided and radially yielding segments over the periphery of the blind opening (3) and
that the sections in-between (5) of the restricting walls are unyielding.

5. A tool according claim 4, characterized by the fact that the height of the segment (7) is the same as the depth of the blind opening (3).

6. A tool according claim 4 or claim 5, characterized by the fact that the volume of the material at the starting point (before the press joint connection process begins) is somewhat greater than the volume of the blind opening (3) minus that of the molded punch (1).

7. A tool according to one of the above claims 4 to 6 characterized by the fact that the segments (7) are movable against the force of a spring.

8. A tool according to claims 7 characterized by the fact that the segments (7) are led into wall openings (10) which receive the segments (7) feature guide walls on the side on the same level as the bottom (12) of the blind opening (3), which run in the radial sliding direction of the segments (7).

9. A tool according to claims 4 - 8 characterized by the fact that the guide walls lying opposite to each other of the segment (7) run parallel to each other into a wall opening (10) on the unyielding wall sections (5).

10. A tool according to claims 7 - 9 characterized by the fact that a leaf spring or spring-pin located on the die provide spring forces.

11. A tool according to claim 10 characterized by the fact that the springs (8,15) are guided in longitudinal grooves (11) in the die (6).

12. A tool according to claims 10 or 11 characterized by the fact that the springs on the far end of the segments are connected together as one piece over a connecting section and that there is an offset (9) of the same in the junction section between the connecting section (7) and the individual springs (6), in the direction of the casing parts.

13. A tool according to claim 12 characterized by the fact that the connecting section is located in a jointing section of the lower die which runs transverse to the direction of the drive.

14. A tool according to claim 12 or 13 characterized by the fact that the connecting section has the form of a cross or a star.

15. A tool according to claims 12 to 14 characterized by the fact that there are grooves in the longitudinal direction and/or on the other side on the lower die bottom section to receive springs and/or of the connecting section.
